(19) United States
(12) Patent Application Publication
(10) Pub. No.: US 2025/0197262 A1
(43) Pub. Date: Jun. 19, 2025

(54) Wastewater Biological Selector System and Methods for Treating Wastewater Process Fluid

(71) Applicant: Red Valve Company. Inc., Pittsburgh, PA (US)

(72) Inventor: Jeffrey T. Kelly, Pittsburgh, PA (US)

(21) Appl. No.: 18/984,575

(22) Filed: Dec. 17, 2024

Related U.S. Application Data
(60) Provisional application No. 63/611,534, filed on Dec. 18, 2023.

(51) Int. Cl. C02F 3/20; C02F 3/00; C02F 3/12; C02F 3/22

(52) U.S. Cl. CPC C02F 3/20; C02F 3/006; C02F 3/1284; C02F 3/22; C02F 2203/006; C02F 2209/04

(57) ABSTRACT

A method for treating a wastewater process fluid includes: distributing air into a vessel having wastewater process fluid with an external air supply through an array of air diffusers; monitoring a state of the wastewater process fluid with an oxygen reduction potential (ORP) probe and a controller in operable communication with the ORP probe; and controlling a rate of the air supply to the wastewater process fluid by cycling of an air blower on and off. The time periods for operating the air blower are based on ORP readings. A biological selector system is also included.

### CROSS-REFERENCE TO RELATED APPLICATIONS

This application claims the benefit of U.S. Provisional Patent Application No. 63/611,534 filed Dec. 18, 2023, the disclosure of which is incorporated herein by reference in its entirety.

### BACKGROUND OF THE INVENTION

### Field of the Invention

This invention generally relates to aeration systems, and more particularly to a wastewater biological system and methods of using the same, such as for processing the reduction of nutrients (e.g., nitrates and phosphates).

### Description of Related Art

In wastewater treatment plants, it is known to aerate wastewater or sludge as part of the wastewater purification process commonly known as the “activated sludge” process. This process typically includes a biological treatment system consisting of a contained volume of wastewater with a dominant aerobic microorganism colony which thrives on biodegradation of the wastewater in an aerobic environment. In order to maintain the requisite aerobic environment, supplemental air must be introduced into the system to promote the dissolution of gaseous oxygen into the liquid phase. The introduction of supplemental air is commonly achieved through the use of either mechanical surface aerators or submerged diffused aerators. The air supply to these systems is intended to run constantly with no interruptions which results in high operational energy costs. The bacteria types and bacteria concentrations in the process fluid are difficult to optimize in a continual aeration process.

Diffused aeration provides mixing energy to the fluid by means of vertical eduction of hydraulic particles into the vertical (buoyant) flow path of discharged gas bubbles. The supply of diffused air to the process provides dissolved oxygen to the process fluid which respirates the bacteria in the process fluid. The majority of wastewater fluids contain bacteria in three groups: dedicated aerobic bacteria, dedicated anaerobic bacteria, and facultative bacteria. Anaerobic bacteria are detrimental to an aerobic process, where high concentrations can result in the production of hydrogen sulfide and methane gas which are undesirable in these processes. Over-aeration can produce excessive concentrations of dedicated aerobic bacteria which can result in the biomass becoming buoyant and not conducive to settling which is required in post aeration processes for removal of the biomass and solids. Current aeration processes provide a constant rate of dissolved oxygen to the fluid which results in a high concentration of dedicated aerobes but does not eliminate all of the dedicated anaerobic bacteria. The majority of air diffusers available (other than duckbill style) are mounted on the top side of the air distribution piping and are problematic in resuspension of settled solids in a process fluid.

Aerobic wastewater treatment processes can be optimized by increasing the concentration of facultative anaerobic bacteria in the process fluid. These bacteria can survive in the stressful environment of alternating low or high oxygen supply to the process fluid. These bacteria exist in an ORP range that has shown not to produce hydrogen sulfide or methane gas (odorous problems). This bacteria is more efficient at the reduction of nutrients in the fluid and has desirable settling characteristics. The reduction of dedicated aerobes and dedicated anaerobes along with the increase in facultative anaerobes will provide an optimized environment for the treatment of biological wastewater.

Applying standard periods of blower run time and off cycles without monitoring the ORP state can result in detrimental effects on the desired bacteria and excessive growth of undesirable bacteria. Currently, there is a lack of public access equations for the optimization of facultative anaerobe development and control of this air cycling process utilizing ORP monitoring.

Thus, it is desirable to provide a diffused aeration system and method with process control for the development and also the elimination of specific bacterial types and their concentrations. It is also desirable to provide a system and process to increase facultative anaerobic bacteria, while at the same time reducing the blower operating power cost over standard diffused aeration systems.

### SUMMARY OF THE INVENTION

In certain non-limiting embodiments, the present disclosure includes a method for treating a wastewater process fluid that includes: distributing air into a vessel comprising wastewater process fluid with an external air supply through an array of air diffusers; monitoring a state of the wastewater process fluid with an oxygen reduction potential (ORP) probe and a controller in operable communication with the ORP probe; and controlling a rate of the air supply to the wastewater process fluid by cycling of an air blower on and off. The time periods for operating the air blower are based on ORP readings.

In certain non-limiting embodiments, the array of air diffusers are positioned on a bottom floor of the vessel. For instance, the array of air diffusers can be oriented with openings located at a surface of a bottom floor of the vessel. The array of air diffusers can include duckbill air diffusers providing backflow prevention of the wastewater process fluid when the air supply is discontinued.

In certain non-limiting embodiments, the air discharged from the array of air diffusers produces coarse bubbles into the wastewater process fluid. The array of air diffusers can also be oriented to produce a controlled loop, hydraulic mixing pattern. Alternatively, the array of air diffusers can be oriented to produce a turbulent, hydraulic mixing pattern.

In certain non-limiting embodiments, one or more computer-readable storage mediums are in operable communication with the controller and contain programming instructions that cause the controller to provide a blower control signal specifying run times and off durations for the blower. The method can also include optimizing the air supply into the vessel over time until the ORP shows the wastewater process fluid at a constant state and reflective of a high population of facultative bacteria. The previously described method can be used to aerate the wastewater process fluid and/or convert the wastewater process fluid to a high population of desired bacteria.

In certain non-limiting embodiments, the present disclosure also relates to a biological selector system. The system can include: a vessel comprising wastewater process fluid; an array of an array of air diffusers positioned within the wastewater process fluid; an oxygen reduction potential (ORP) probe positioned within the wastewater process fluid; a controller in operable communication with the ORP probe; and one or more computer-readable storage mediums in operable communication with the controller and containing programming instructions that cause the controller to monitor a state of the wastewater process fluid, and control a rate of the air supply to the wastewater process fluid by cycling of an air blower on and off.

In certain non-limiting embodiments, the blower is in fluid communication with an air supply inlet pipe that extends into the vessel and is attached to diffuser distribution piping comprising the array of air diffusers. The array of air diffusers can be positioned on a bottom floor of the vessel. For instance, the array of air diffusers can be oriented with openings located at a surface of a bottom floor of the vessel. The array of air diffusers can include duckbill air diffusers providing backflow prevention of the wastewater process fluid when the air supply is discontinued.

In certain non-limiting embodiments, the array of air diffusers can also be oriented to produce a controlled loop, hydraulic mixing pattern. Alternatively, the array of air diffusers can be oriented to produce a turbulent, hydraulic mixing pattern.

In certain non-limiting embodiments, the one or more computer-readable storage mediums further contain programming instructions that cause the controller to provide a blower control signal specifying run times and off durations for the blower.

The present disclosure also relates to the following aspects.

Aspect 1: a method for treating a wastewater process fluid comprising: distributing air into a vessel comprising wastewater process fluid with an external air supply through an array of air diffusers; monitoring a state of the wastewater process fluid with an oxygen reduction potential (ORP) probe and a controller in operable communication with the ORP probe; and controlling a rate of the air supply to the wastewater process fluid by cycling of an air blower on and off, wherein time periods for operating the air blower are based on ORP readings.

Aspect 2: The method of aspect 1, wherein the array of air diffusers are positioned on a bottom floor of the vessel.

Aspect 3: The method of aspects 1 or 2, wherein the array of air diffusers are oriented with openings located at a surface of a bottom floor of the vessel.

Aspect 4: The method of anyone of aspects 1-3, wherein the array of air diffusers are duckbill air diffusers providing backflow prevention of the wastewater process fluid when the air supply is discontinued.

Aspect 5: The method of anyone of aspects 1-4, wherein air discharged from the array of air diffusers produces coarse bubbles into the wastewater process fluid.

Aspect 6: The method of anyone of aspects 1-5, wherein the array of air diffusers are oriented to produce a controlled loop, hydraulic mixing pattern.

Aspect 7: The method of anyone of aspects 1-5, wherein the array of air diffusers are oriented to produce a turbulent, hydraulic mixing pattern.

Aspect 8: The method of anyone of aspects 1-7, wherein one or more computer-readable storage mediums are in operable communication with the controller and contain programming instructions that cause the controller to provide a blower control signal specifying run times and off durations for the blower.

Aspect 9: The method of anyone of aspects 1-8, further comprising optimizing the air supply into the vessel over time until the ORP shows the wastewater process fluid at a constant state and reflective of a high population of facultative bacteria.

Aspect 10: The method of anyone of aspects 1-9, wherein the method aerates the wastewater process fluid.

Aspect 11: The method of anyone of aspects 1-10, wherein the method converts the wastewater process fluid to a high population of desired bacteria.

Aspect 12: A biological selector system comprising: a vessel comprising wastewater process fluid; an array of air diffusers positioned within the wastewater process fluid; an oxygen reduction potential (ORP) probe positioned within the wastewater process fluid; a controller in operable communication with the ORP probe; and one or more computer-readable storage mediums in operable communication with the controller and containing programming instructions that cause the controller to monitor a state of the wastewater process fluid, and control a rate of the air supply to the wastewater process fluid by cycling of an air blower on and off.

Aspect 13: The system of aspect 12, wherein the blower is in fluid communication with an air supply inlet pipe that extends into the vessel and is attached to diffuser distribution piping comprising the array of air diffusers.

Aspect 14: The system of aspects 12 or 13, wherein the array of air diffusers are positioned on a bottom floor of the vessel.

Aspect 15: The system of anyone of aspects 12-14, wherein the array of air diffusers are oriented with openings located at a surface of a bottom floor of the vessel.

Aspect 16: The system of anyone of aspects 12-15, wherein the array of air diffusers are duckbill air diffusers providing backflow prevention of the wastewater process fluid when the air supply is discontinued.

Aspect 17: The system of anyone of aspects 12-16, wherein the array of air diffusers are oriented to produce a controlled loop, hydraulic mixing pattern.

Aspect 18: The system of anyone of aspects 12-16, wherein the array of air diffusers are oriented to produce a turbulent, hydraulic mixing pattern.

Aspect 19: The system of anyone of aspects 12-18, wherein the one or more computer-readable storage mediums further contain programming instructions that cause the controller to provide a blower control signal specifying run times and off durations for the blower.

### BRIEF DESCRIPTION OF THE DRAWINGS

FIG. 1 is a front cross-sectional view of a biological selector system according to a non-limiting embodiment of the present disclosure.

### DESCRIPTION OF THE INVENTION

For the purpose of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plurals encompasses the singular, unless specifically stated otherwise. In addition, in this application, the use of “or” means “and/or” unless specifically stated otherwise, even though “and/or” may be explicitly used in certain instances.

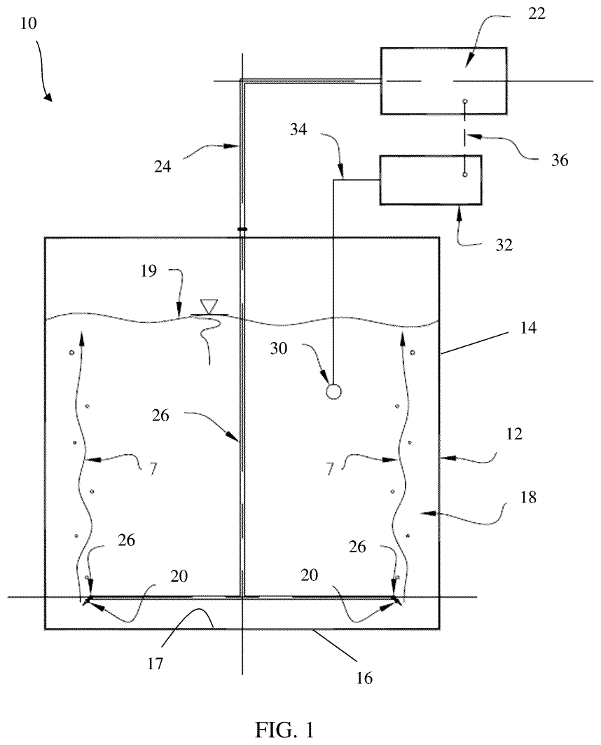

Referring to FIG. 1, a wastewater biological system 10 comprises a vessel 12 having side walls 14 and a bottom wall/floor 16. A wastewater process fluid 18 is introduced into the vessel 12 for treatment. As further shown in FIG. 1, an array of air diffusers 20 are used to distribute an external air supply into the wastewater process fluid 18 contained in the vessel 12. The array of air diffusers 20 are positioned within the wastewater process fluid 18 contained in the vessel 12. For example, the array of air diffusers 20 can be positioned on or near a surface 17 of the bottom wall/floor 16 in the vessel 12.

In certain non-limiting embodiments, as shown in FIG. 1, the vessel 12 further includes a blower or compressor 22 that distributes air into an air supply inlet pipe 24 that extends into the vessel 12 to diffuser distribution piping 26. The diffuser distribution piping 26 can be attached to the array of air diffusers 20. The external air supply can be distributed from the blower or compressor 22, into an air supply inlet pipe 24, to diffuser distribution piping 26, and finally to the array of air diffusers 20 that distributes air into the wastewater process fluid 18 contained in the vessel 12.

It will be appreciated that the array of air diffusers 20 can provide coarse bubbles into the wastewater process fluid 18. Non-limiting examples of such air diffusers 20 include duckbill check valves that provide backflow prevention of fluid, for example when the air supply is discontinued. An example of a duckbill check valve is described in U.S. Pat. No. 4,607,663, which is incorporated herein by reference in its entirety.

In certain non-limiting embodiments, air discharged from the array of air diffusers 20 travels vertically in the wastewater process fluid 18 and educting hydraulic particles into the vertical path 7 to the fluid surface 19 generating mixing of the wastewater process fluid 18. It is appreciated that the array of air diffusers 20 can be oriented to produce a desired pattern for mixing the wastewater process fluid 18. For example, the array of air diffusers 20 can be oriented to produce a controlled loop (hydraulic) mixing pattern, or a turbulent (hydraulic) mixing pattern sufficient to produce adequate energy for mixing of the wastewater process fluid 18 and solids contained within the wastewater process fluid 18.

Referring again to FIG. 1, an oxygen reduction potential (ORP) probe 30 is positioned within the wastewater process fluid 18 contained in the vessel 12. The ORP probe 30 is configured to determine the ORP in the wastewater process fluid 18. The ORP probe 30 is in operable communication with a controller 32 or other processor, such as through a signal wire 34. The controller 32 can also be in operable communication with the blower or compressor 22, such as through a signal wire 36.

One or more computer-readable storage mediums can be in operable communication with the controller 32. The computer-readable storage mediums can contain programming instructions that, when executed, cause the controller 32 to perform multiple tasks. It is appreciated that the controller 32 may include one or more microprocessors, CPUs, and/or other computing devices.

In certain non-limiting embodiments, the programming instructions include algorithms that utilize the ORP data over a timed period that causes the controller 32 to provide a blower control signal specifying the run time for the blower or compressor 22. This information can be used to determine the run durations as well as the off durations for the blower or compressor 22.

During the periods when the air supply has been discontinued (off cycle), bacterial biomass will slowly settle to the vessel floor 16 and accumulate. In certain non-limiting embodiments, the array of air diffusers 20 are oriented with the discharge point near the floor 16 to provide resuspension of the settled solids during the next aeration “on cycle”.

In certain non-limiting embodiments, the present disclosure relates to a method of treating a wastewater process fluid 18, such as a method for aerating a wastewater process fluid 18 and/or a method for conversion of the wastewater process fluid 18. In some non-limiting embodiments, the method includes distributing air into a vessel 12 comprising wastewater process fluid 18 with an external air supply through an array of air diffusers 20, and monitoring a state of the wastewater process fluid 18 with the ORP probe 30 and the controller 32. The array of air diffusers 20 can include any of the previously described diffusers 20, such as a duckbill check valve. The array of air diffusers 20 can also be positioned within the vessel 12 as previously described to produce a desired pattern for mixing the wastewater process fluid 18 (e.g., oriented to produce a controlled loop (hydraulic) mixing pattern, or a turbulent (hydraulic) mixing pattern.

The method further includes controlling a rate of the air supply to the wastewater process fluid 18 by cycling of the air blower or compressor 22 on and off, where time periods for operating the blower or compressor 22 are based on ORP readings. As previously described, one or more computer-readable storage mediums are in operable communication with the controller 32 and contain programming instructions that, when executed, cause the controller 32 to perform multiple tasks including utilizing the ORP data over a timed period to cause the controller 32 to provide a blower control signal specifying the run time for the blower or compressor 22.

It was found that providing periods of air supply will generate an aerobic environment which is harmful to dedicated anaerobic bacteria and will result in the reduction of the quantity of dedicated anaerobic bacteria. It was also found that providing periods of discontinued airflow will generate an anaerobic environment which is harmful to dedicated aerobic bacteria and will result in the reduction of the quantity of dedicated aerobic bacteria. Through the reduction of the noted bacteria, the facultative anaerobic bacteria will begin to proliferate in the wastewater process fluid 18.

In certain non-limiting embodiments, the method further includes optimizing the process control over time with the ORP probe 30 and controller 32 until the ORP shows the wastewater process fluid 18 at a constant state and reflective of a high population of facultative bacteria (e.g., as compared to the population of facultative bacteria of a different system and method). As such, the ORP probe 30 and controller 32 can constantly monitor the state of the wastewater process fluid 18 in reference to the ORP state. ORP values for wastewater processes range from +300 to −300 and have desirable ranges for each bacteria type. Over this time, the controller 32 monitors the ORP state and determines the blower or compressor 22 run times required for optimization of the environment for facultative anaerobes. As the concentration of bacteria for each group changes, the ORP state also changes and the controller 32 will adjust the blower or compressor 22 run times with respect to the current ORP state measured.

It is appreciated that the method steps can be selected to aerate the system by supplying external air to the wastewater process fluid 18. The aeration can be controlled as previously described with the ORP probes 30, controller 32, and computer-readable storage mediums.

It is further appreciated that the method steps can be selected for conversion of the wastewater process fluid 18. The conversion can be controlled by supplying external air supply to the wastewater process fluid 18 to produce an aerobic environment, and then terminating the supply air to produce an anaerobic environment. The conversion can be controlled as previously described with the ORP probes 30, controller 32, and computer-readable storage mediums. As indicated, alternating the environmental condition repeatedly produces a stressful environment for the bacteria which will result in the proliferation of desirable bacteria (facultative anaerobes) and the reduction of non-desirable bacteria (dedicated aerobic and dedicated anaerobic bacteria). The wastewater process fluids 18 containing these high populations of facultative anaerobes are resistant to the discharge of hydrogen sulfide gas (odorous conditions) and more adaptable at removal of wastewater nutrients (nitrates and phosphates).

The system 10 and method of the present disclosure also reduces the operational and power cost of a standard diffused air process by reducing the run time of the blower or compressor 22, while increasing the population of facultative anaerobes. It is appreciated that this method can be designated as biological selection and the system 10 performing this activity can be designated as a biological selector.

Whereas particular embodiments of this invention have been described above for purposes of illustration, it will be evident to those skilled in the art that numerous variations of the details of the present invention may be made without departing from the invention.

The invention claimed is:

1. A method for treating a wastewater process fluid comprising:
distributing air into a vessel comprising wastewater process fluid with an external air supply through an array of air diffusers;
monitoring a state of the wastewater process fluid with an oxygen reduction potential (ORP) probe and a controller in operable communication with the ORP probe; and
controlling a rate of the air supply to the wastewater process fluid by cycling of an air blower on and off,
wherein time periods for operating the air blower are based on ORP readings.

2. The method of claim 1, wherein the array of air diffusers are positioned on a bottom floor of the vessel.

3. The method of claim 1, wherein the array of air diffusers are oriented with openings located at a surface of a bottom floor of the vessel.

4. The method of claim 1, wherein the array of air diffusers are duckbill air diffusers providing backflow prevention of the wastewater process fluid when the air supply is discontinued.

5. The method of claim 1, wherein air discharged from the array of air diffusers produces coarse bubbles into the wastewater process fluid.

6. The method of claim 1, wherein the array of air diffusers are oriented to produce a controlled loop, hydraulic mixing pattern.

7. The method of claim 1, wherein the array of air diffusers are oriented to produce a turbulent, hydraulic mixing pattern.

8. The method of claim 1, wherein one or more computer-readable storage mediums are in operable communication with the controller and contain programming instructions that cause the controller to provide a blower control signal specifying run times and off durations for the blower.

9. The method of claim 1, further comprising optimizing the air supply into the vessel over time until the ORP shows the wastewater process fluid at a constant state and reflective of a high population of facultative bacteria.

10. The method of claim 1, wherein the method aerates the wastewater process fluid.

11. The method of claim 1, wherein the method converts the wastewater process fluid to a high population of desired bacteria.

12. A biological selector system comprising:
a vessel comprising wastewater process fluid;
an array of air diffusers positioned within the wastewater process fluid;
an oxygen reduction potential (ORP) probe positioned within the wastewater process fluid;
a controller in operable communication with the ORP probe; and
one or more computer-readable storage mediums in operable communication with the controller and containing programming instructions that cause the controller to monitor a state of the wastewater process fluid, and control a rate of the air supply to the wastewater process fluid by cycling of an air blower on and off.

13. The system of claim 12, wherein the blower is in fluid communication with an air supply inlet pipe that extends into the vessel and is attached to diffuser distribution piping comprising the array of air diffusers.

14. The system of claim 12, wherein the array of air diffusers are positioned on a bottom floor of the vessel.

15. The system of claim 12, wherein the array of air diffusers are oriented with openings located at a surface of a bottom floor of the vessel.

16. The system of claim 12, wherein the array of air diffusers are duckbill air diffusers providing backflow prevention of the wastewater process fluid when the air supply is discontinued.

17. The system of claim 12, wherein the array of air diffusers are oriented to produce a controlled loop, hydraulic mixing pattern.

18. The system of claim 12, wherein the array of air diffusers are oriented to produce a turbulent, hydraulic mixing pattern.

19. The system of claim 12, wherein the one or more computer-readable storage mediums further contain programming instructions that cause the controller to provide a blower control signal specifying run times and off durations for the blower.
